(19) United States
(12) Patent Application Publication
(10) Pub. No.: US 2020/0061796 A1
(43) Pub. Date: Feb. 27, 2020

(54) ERGONOMIC APPARATUS FOR HANDHELD TOOLS AND POWERED TOOLS

(71) Applicant: Magnetic Focus, LLC, Ronan, MT (US)

(72) Inventors: Matthew Jore, Ronan, MT (US); Jackson Jore, Ronan, MT (US); Dallas Jore, Ronan, MT (US); Brent Passwater, Ronan, MT (US)

(21) Appl. No.: 16/546,339

(22) Filed: Aug. 21, 2019

Related U.S. Application Data
(60) Provisional application No. 62/721,130, filed on Aug. 22, 2018.

(51) Int. Cl. B25F 5/02; A01D 34/90; B25F 3/00; B25G 1/10

(52) U.S. Cl. CPC B25F 5/02; A01D 34/902; A01D 34/4165; B25G 1/102; B25F 3/00

(57) ABSTRACT

An ergonomic apparatus relates to simplifying and making more ergonomic use of handheld tool products. In one embodiment, an ergonomic apparatus comprises a handle for gripping that is attached to a work tool on a working end and attached to a base structure extending to and adjustably encompassing the wrist and forearm so that the weight of an attachable work tool and leverage provided to the user is shifted farther back on the arm where the ergonomic apparatus is substantially secured on the forearm with an adjustable means which acts to contain the forearm.

### CROSS REFERENCE TO RELATED APPLICATION

This application claims the benefit of U.S. Provisional Application No. 62/721,130, filed Aug. 22, 2018, which is hereby incorporated by reference in its entirety.

### TECHNICAL FIELD

The present disclosure is generally related to handheld products, and in particular, handheld tool products with ergonomic attributes.

### BACKGROUND

Conventional handheld tool products typically use handles that are not ergonomically optimized. Several examples include conventional shovels, rakes, hoes, and other such types of products. These products typically have a long straight handle that the user grips at a position close to the end opposite the working end. Likewise, handheld powered work tools, such as grass trimmers, leaf blowers, hedge clippers, and similar tools, are designed to be held by handles that are supported by the wrist, oftentimes at angles that are not ergonomically oriented, resulting in increased stress on the wrist, hand, arm, and body. The grip, as used in conventional tool products, is typically at an angle of between 160 and 180 degrees, which is not the most natural angle for a wrist to be positioned during work. This unnatural angle increases stresses on the wrist, hand, and arm and oftentimes the stress is transferred to the shoulder and other parts of the body. The natural angle for a wrist, as a hand grips a handle, relative to the top of the forearm, is at an angle where the handle grip is approximately 100 to 115 degrees from the plane which is parallel to the top of the forearm. There are some handle grips in the market that attempt to address ergonomics in one fashion or another. Presently, there is a need for an apparatus that is ergonomically designed to hold the hand, wrist, and forearm at an angle that provides the least amount of stress on the hand, wrist, arm, shoulder, back, hips, and legs.

### SUMMARY OF THE INVENTION

In one embodiment, an apparatus comprising a handle for gripping that is attached to a work tool on a working end and attached to a base structure extending to and adjustably encompassing the wrist and forearm so that the weight of the work tool and leverage of the user is shifted farther back on the arm. The apparatus is substantially secured on the forearm with an adjustable means which acts to contain the forearm.

### BRIEF DESCRIPTION OF THE DRAWINGS

Many aspects of certain embodiments of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is an isometric rear view of an embodiment of an ergonomic apparatus secured to an arm of a person.

FIG. 2 is a top view of an embodiment of an ergonomic apparatus showing the fit of the hand and handle relative to the arm and base.

FIG. 3 is a front isometric view of an embodiment of an ergonomic apparatus including a nose section.

FIG. 4 is a rear view of an embodiment of an ergonomic apparatus including an embodiment of an energy storage mechanism.

FIG. 5 is a side view of an embodiment of an ergonomic apparatus wherein adjustable connections allowing the encasement of the forearm are positioned.

FIG. 6 is an isometric view of an embodiment of an ergonomic apparatus illustrating one embodiment of an ergonomic handle grip.

FIG. 7 is a view showing one embodiment of a quick connect system in the nose section of an embodiment of an ergonomic apparatus.

FIG. 8 is an isometric view showing an embodiment of an ergonomic apparatus having one embodiment of an adjustable mechanism for different forearm sizes.

FIG. 9 is a view showing one embodiment of an adjustable mechanism to accommodate different forearm sizes.

FIG. 10 is a set of drawings providing additional detail for one embodiment of an adjustable and locking system built into an embodiment of an ergonomic apparatus for different forearm sizes.

FIG. 11 is a view showing one embodiment of an electronic controller and energy storage mechanism and heat sink thereto.

FIG. 12 is a view illustrating an embodiment of an ergonomic apparatus that provides an ergonomic handle and forearm containment system for attaching various tools.

FIG. 13 is a side elevation view with isolation views of select components of an embodiment of an ergonomic apparatus that is secured permanently to a tool or implement.

FIG. 14 is a schematic diagram showing, in cut-away view, an embodiment of an ergonomic apparatus for permanently fixed tools or implements.

FIG. 15 is a schematic diagram showing, in cut-away view, an embodiment of an ergonomic apparatus for interchangeable tools or implements.

### DETAILED DESCRIPTION OF EMBODIMENTS

The present invention relates to simplifying and making more ergonomic use of handheld tool products. In particular, one embodiment of the present invention is generally related to the carrying and operation of handheld products, powered or unpowered, where weight distribution and ergonomic function are optimized and where cost of purchase is reduced by utilization of a common apparatus that is donned on the wrist and forearm while being gripped by the hand and that is equipped with a lock and release mechanism that allows the interchangeability of various non-powered work tools or powered work tools, wherein an energy storage system is optionally incorporated into the apparatus when a powered tool is utilized. In some embodiments, the lock and release mechanism may be omitted and a collar used to secure (permanently) a tool or implement.

Digressing briefly, as explained above, conventional handheld tool products typically use handles that are not ergonomically optimized, typically placing too much stress on the wrist, hand, and arm (and oftentimes the stress is transferred to the shoulder and other parts of the body) due to a grip that places the wrist at an unnatural angle. In contrast, certain embodiments of an ergonometric apparatus of the present invention are disclosed where the weight bearing is shifted farther back on the arm and is substantially secured on the forearm with an adjustable means which acts to contain the forearm, offering much greater leverage and usability. One advantage of forearm containment is that the implement can be utilized in any rotational direction while maintaining the natural angle of the wrist to forearm. In addition, the ability to selectively adjust to an individual wrist and/or forearm circumference with a quick adjust feature allows comfort for a variety of users, each having unique wrist and forearm dimensions.

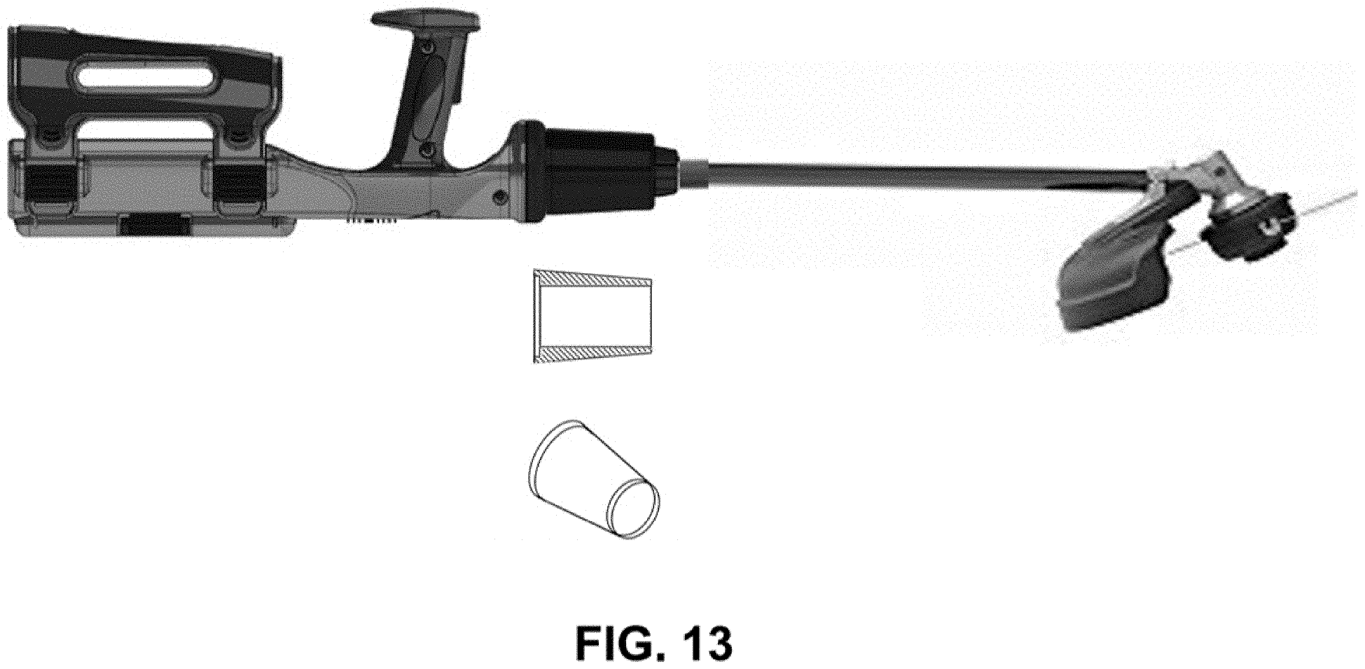

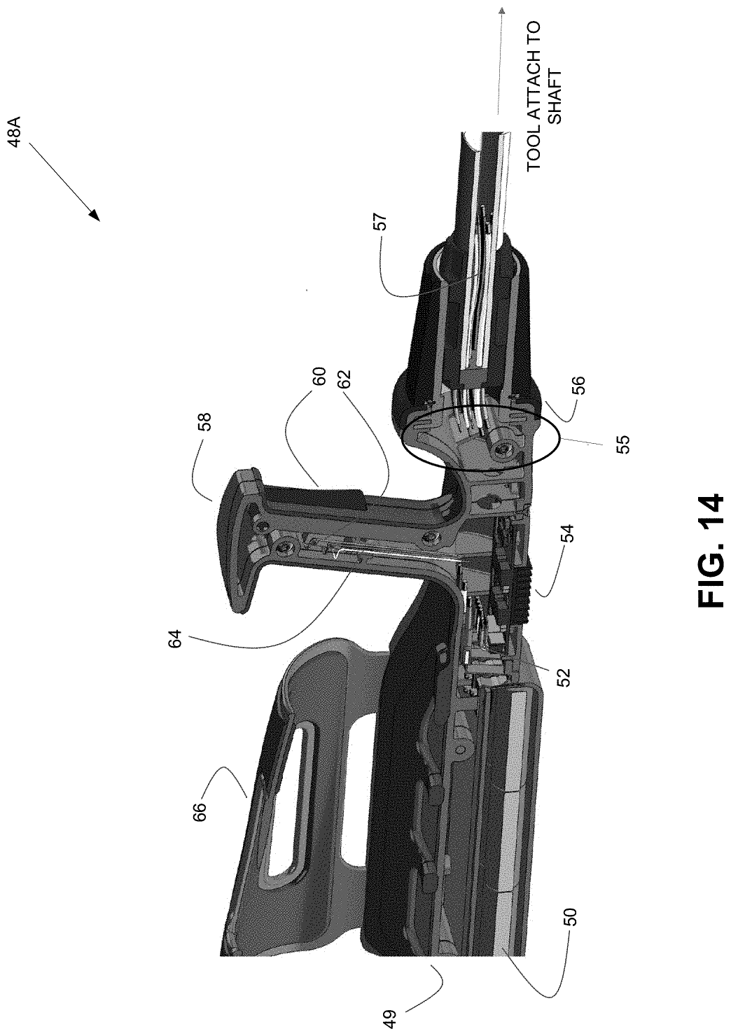

Having summarized certain features of an ergonometric apparatus of the present invention, reference will now be made in detail to the description of an ergonometric apparatus as illustrated in the drawings. While an ergonometric apparatus will be described in connection with these drawings, there is no intent to limit it to the embodiment or embodiments disclosed herein. For instance, the illustrations and descriptions of the disclosed ergonometric apparatus are not intended to be limiting, as there are a number of different configurations that might be utilized to achieve the utility of ergonomics, usability, and weight balancing brought by the present invention according to variations that are contemplated to be within the scope of the invention as would be appreciated by one having ordinary skill in the art. Also, though emphasis below is on an embodiment of an ergonometric apparatus configured for detachable connection to any one of a variety of tools or implements, certain embodiments that share a similar structure except for the nature of the tool-connection are disclosed in conjunction with FIGS. 13 and 14. Note that one or more features described for one embodiment may be combined or replaced with one or more features of other embodiments. In other words, the various embodiments may comprise components that are combined and/or interchangeable. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the scope of the disclosure as defined by the appended claims. Further, it should be appreciated in the context of the present disclosure that the claims are not necessarily limited to the particular embodiments set out in the description.

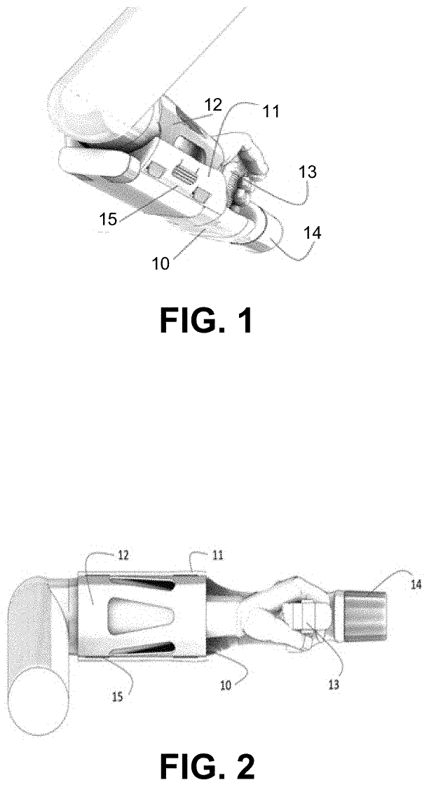

In one embodiment, and referring to FIG. 1, an ergonometric apparatus has a main body, or base 10 constructed with a platform to place the forearm and comprises sidewall portions 11 that adjustably attach to a forearm cover 12 to encompass the forearm, said platform having a built-in, ergonomically configured handle grip 13 for gripping by a hand, and further having a nose portion 14 for detachably mechanically and electrically connecting powered work tools. The grip 13 comprises in one embodiment a substantially flat mounting portion that mounts to the base (e.g., mounts to or is in contact with a platform of the base, the platform coplanar or substantially coplanar with the mounting portion). In one embodiment, the nose portion 14 comprises a cylindrical shape. In some embodiments, the nose portion 14 may comprise a shape of a different geometry than cylindrical (e.g., cube-shape, etc.). It is noted that the hand and arm shown are not intended to be specific to the right or left. The ergonometric apparatus is intended to be used with either left or right hand and arm.

In some embodiments, the forearm cover 12 and sidewall portions 11 of the base 10 are adjustable by, for instance, a stepped adjustable locking means 15 on either side of the base and in other embodiments, one side of the sidewall portions may be fixed with a hinging mechanism to the base. Examples of such embodiments are illustrated in FIG. 2, where like-numbered reference numbers refer to the same or similar components. Note that the forearm cover 12 may be comprised of any suitable material.

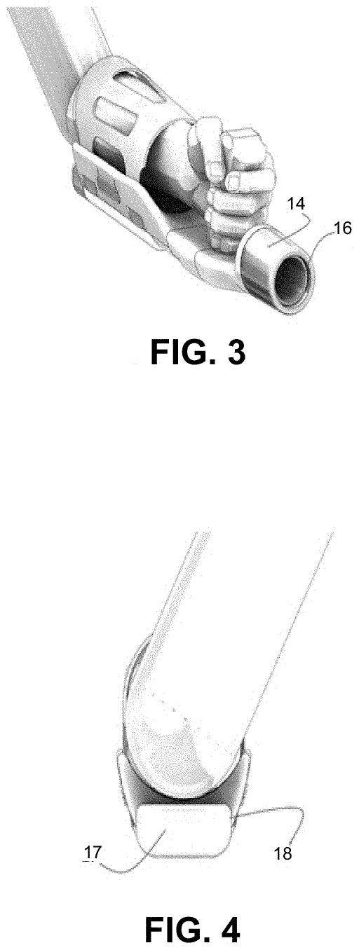

One advantage of the ergonometric apparatus is that it can serve as a single ergonomic support and weight bearing and balancing apparatus for an indefinite number of work tools. Referring now to FIG. 3, one embodiment of an ergonometric apparatus shows the incorporation into the nose portion 14 of a lock and release mechanism 16. In this embodiment, the lock and release mechanism 16 allows for mechanical attachment of numerous work tools. In other embodiments, the lock and release mechanism 16 allows for electrical connection between the ergonometric apparatus and numerous work tools. In one embodiment, the lock and release mechanism 16 comprises a threaded coupling comprised of a thread made on said cylindrical nose portion 14 and a mating thread made on tool attachments for threading onto the thread of said cylindrical nose portion 14.

In one embodiment, the base includes a lock and release mechanism that is comprised of a ball and groove coupling. The ball and groove coupling including an oval shaped open ring positioned in a recess on a nose portion of the base and one or more balls positioned in one or more tapered holes in the nose portion. In one embodiment, the one or more balls positioned in the one or more tapered holes do not protrude beyond an entrance of the one or more tapered holes. The ball and groove coupling further includes a sleeve that circumferentially and slidably covers the one or more balls positioned in the one or more tapered holes. The sleeve includes internal grooves shaped to interface with the oval shaped open ring and with the one or more balls. In one embodiment, one of the internal grooves includes a recess shaped to contain and hold the oval shaped open ring in either one of two positions, wherein one of the internal grooves includes a recess shaped to contain and hold the oval shaped open ring in one of two positions and one of the internal grooves receives the one or more balls when the sleeve is in one of two positions.

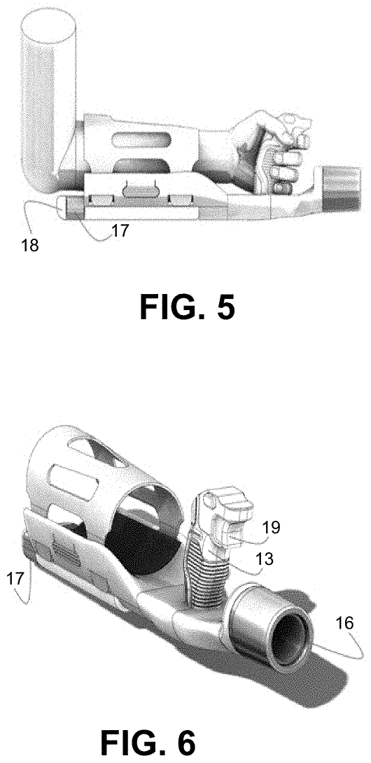

Attention is now directed to FIG. 4 and FIG. 5. In one embodiment, an energy storage device 17 in the form of batteries, fuel cells, or other types of energy storage devices, resides in a container 18 that is attachable to the base and is positioned to extend from under the wrist to a position in close proximity to the elbow of the user, causing the weight of the energy storage device 17 and container 18 to be distributed beyond the wrist and towards the elbow. Note that energy storage device may include an internal power source or external power source. This configuration allows a user to gain more of a lever arm, as opposed to the methods used in most conventional handheld power products, the latter which burden the wrist with the entire weight of the product.

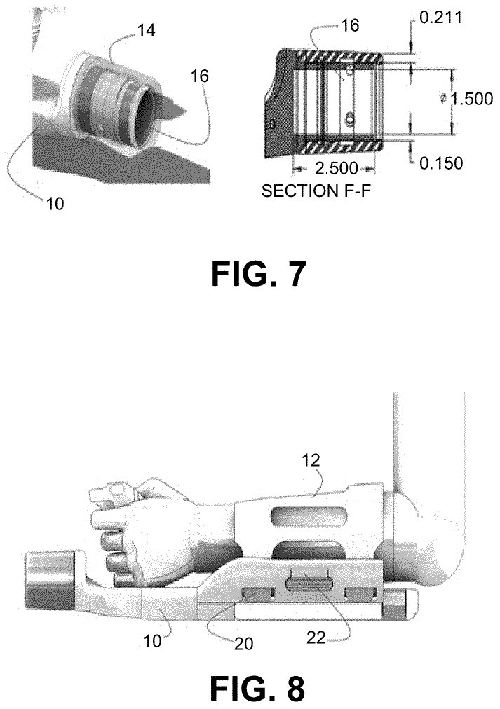

Referring now to FIG. 6, shown is an embodiment of an ergonometric apparatus that has an ergonomically configured handle grip 13 with a built-in power trigger switch 19. In embodiments of an ergonometric apparatus that include an energy storage device 17, this trigger switch 19 (e.g., electrical switch) allows for the control of an electrical connection (e.g., allowing a draw of current) between the ergonometric apparatus and various work tool attachments configured with a mating component 20 (shown in FIG. 8) to the lock and release mechanism 16 connection means. In one embodiment, an interface between base 10 and nose portion 14 of the ergonometric apparatus and the various work tools is illustrated in FIG. 7. Shown is one example of a lock and release mechanism 16 incorporated into nose portion 14 of base 10 and into the connectable mating component 20 at the non-working end of each of the numerous work tools.

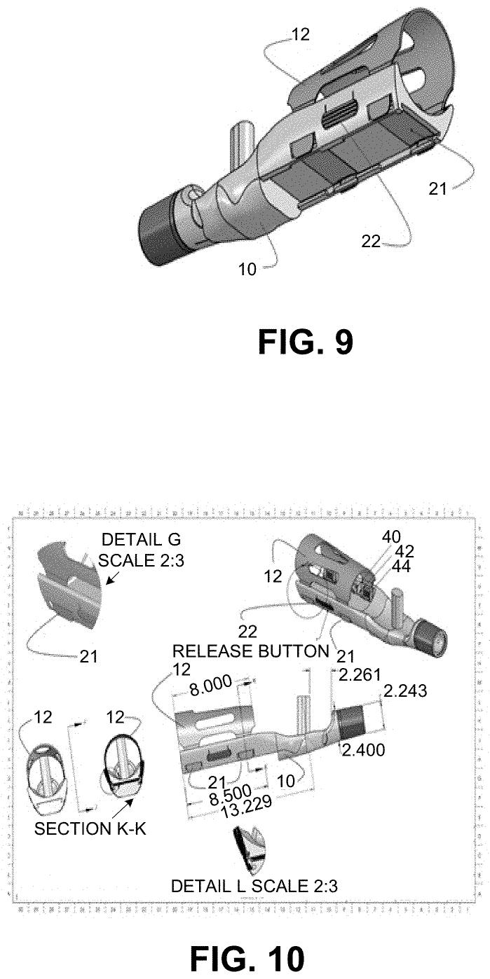

Referring to FIGS. 8, 9, and 10, an embodiment of an adjustable locking mechanism 21 of forearm cover 12 relative to base 10 of the ergonometric apparatus is illustrated. There are a number of methods that could be used to allow for the easy adjustment and locking of forearm cover 12 to base 10. In the embodiment shown in FIGS. 8, 9, and 10, a quick release tab 22 allows a user to release more than one adjustable locking mechanism at once. Also shown is the inside of the release button 40, connecting rod 42, and ratchet release 44.

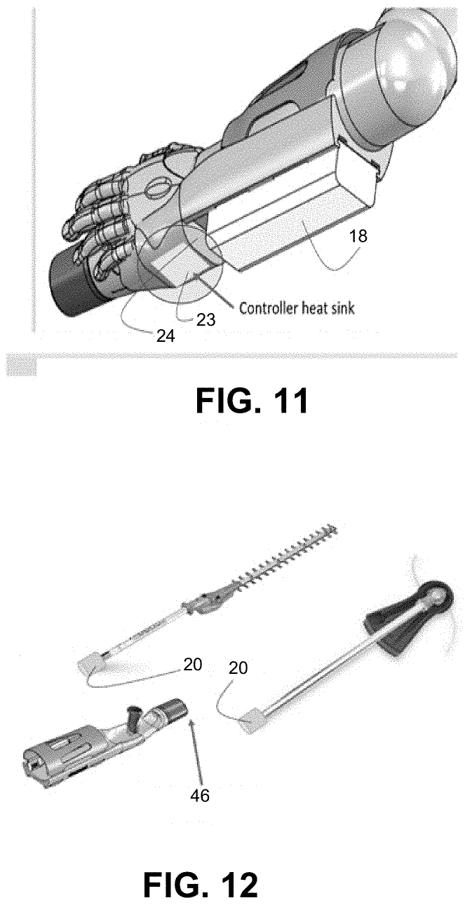

In FIG. 11, an embodiment of an energy storage container 18 is shown, along with one example position for a controller heat sink 23 to dissipate heat generated from energy storage controller device 24.

Shown in FIG. 12 are examples of work tools equipped with mating component 20 of the ergonometric apparatus. The ergonometric apparatus may be attached and detached (detachably coupled) to any one of a variety of tools and/or implements, such as via a quick change connection 46.

FIG. 13 shows yet another embodiment of an ergonometric apparatus that is configured for permanent (not detachably coupled) attachment to a tool or implement. Features described above for the ergonometric apparatus may be used here, except that the lock and release is omitted since permanent attachment is contemplated in this embodiment. As shown, the ergonometric apparatus of FIG. 13 comprises a collar that secured to a tool (e.g., a shaft of the tool), enabling a permanent attachment (and disallowing detachable coupling, such as to be used with other tools and/or implements). That is, the ergonometric apparatus of FIG. 13 illustrates an example permanent, mechanical attachment to provide a dedicated, non-interchangeable tool (e.g., weed trimmer).

FIG. 14 provides a schematic diagram that illustrates in further detail one embodiment of an example ergonometric apparatus 48A that is configured for permanent (non-interchangeable) attachment to any one of a variety of tools or implement attachments. In the depicted embodiment, the ergonometric apparatus 48A comprises a base 49, an energy storage device 50 with electrical contacts, wiring 52 from the energy storage device 50 to a motor controller 54, the motor controller 54, a terminal connector 55 with pins and wires to the motor controller 54, a nose 56 comprising a collar to permanently affix (e.g., electrically, using permanently affixed wiring 57 from the controller 54, and mechanically attach, also collectively referred to herein as a electrical/mechanical connecting means) to one of a variety of motorized tools (e.g., trimmer) attached to a distal shaft end, a grip handle 58 comprising a trigger 60 and switch 62, wiring 64 from the trigger 60 and switch 62 to the motor controller 54, and a forearm cover 66. In general, the energy storage device (e.g., a battery) 50 is connected to the motor controller 54, which in turn is connected to, and activated by, the trigger switch 62 and which is also connected (e.g., wired directly) to a three phase motor that provides torque and motion in the affixed tool. In one embodiment, the wires (e.g., connecting or connection means) include three wires for the three phases and five wires for sensors on the motor that communicate with the motor controller 54. Note that in some embodiments, a cheaper, though often less efficient, DC motor may be used, in which case only two wires/connector plug may be used.

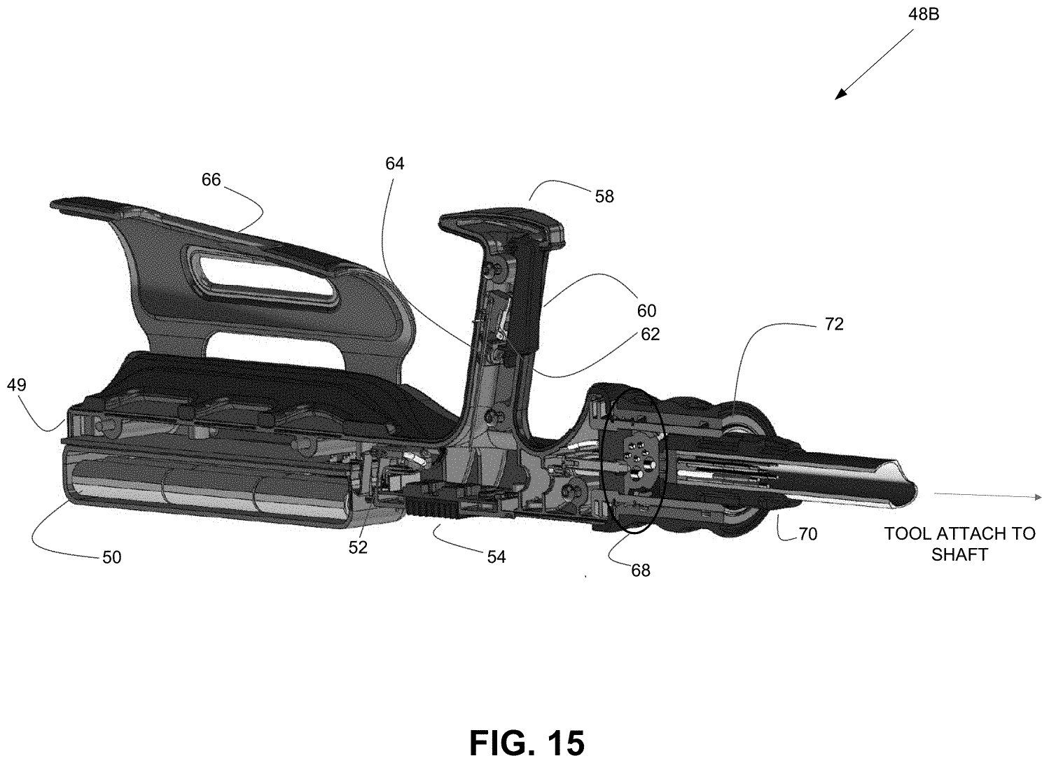

FIG. 15 provides a schematic diagram that illustrates in further detail one embodiment of an example ergonometric apparatus 48B that is configured for any one of a variety of detachable (interchangeable) tools or implement attachments using a detachable (both electrically and mechanically) lock and release mechanism. Components that are similar among the apparatuses 48A and 48B are referenced with the same reference numbers. In the depicted embodiment, the ergonometric apparatus 48B comprises the base 49, the energy storage device 50 with electrical contacts, the wiring 52 from the energy storage device 50 to a motor controller 54, the motor controller 54, a terminal connector 68 with pins and wires to the motor controller 54, a nose 70 comprising a lock and release connector on a proximal shaft end to electrically and mechanically (electrical/mechanical connecting means) attach (detachably) one of a variety of motorized tools (e.g., trimmer) attached to a distal shaft end, a lock and release collar 72 with inner grooves for ball detent, the grip handle 58 comprising the trigger 60 and switch 62, the wiring 64 from the trigger 60 and switch 62 to the motor controller 54, and the forearm cover 66. In general, the energy storage device (e.g., a battery) 50 is connected to the motor controller 54, which in turn is connected to, and activated by, the trigger switch 62 and which is also connected (via the electrical/mechanical connecting means) to a three phase motor that provides that provides torque and motion in the attached tool. In one embodiment, the wires (e.g., connecting or connection means) include three wires for the three phases and five wires for sensors on the motor that communicate with the motor controller. Note that in some embodiments, a cheaper, though often less efficient, DC motor may be used, in which case only two wires/connector plug may be used.

The illustration and narrative disclosed herein of the present invention is specific to an architecture that provides for embodiments that create a new invention used for the ergonomic and weight distribution advantages listed. However, these examples are illustrative, and hence the invention is not limited to such specific illustrated embodiments. Instead, any number of arrangements can be derived by the structure and methods of the invention, including switch means, adjustable means, lock and release means, and so on.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein. Although the systems have been described with reference to the example embodiments illustrated in the attached figures, it is noted that equivalents may be employed and substitutions made herein without departing from the scope of the disclosure as protected by the following claims.

At least the following is claimed:

1. An apparatus for wearing on a wrist and forearm of a person, the apparatus comprising:
a handle grip for gripping with a hand, said handle grip attached to a base extending from the handle grip along the forearm to a position near an elbow of the person,
said base including a platform for positioning and placing a forearm when the handle grip is gripped, said base having sidewall portions on each side that connect to a forearm cover, said forearm cover positioned around the forearm to substantially encase a circumference of the forearm,
said base having a nose portion extending distally in front of the handle grip.

2. The apparatus of claim 1, wherein said nose portion is configured with a lock and release mechanism used for attachment and detachment of various tools and implements.

3. The apparatus of claim 2, wherein said nose portion is cylindrical.

4. The apparatus of claim 3, wherein said lock and release mechanism is comprised of a threaded coupling comprised of:
a thread made on said cylindrical nose portion; and
a mating thread made on tool attachments for threading onto the thread of said cylindrical nose portion.

5. The apparatus of claim 1, wherein said base includes a lock and release mechanism that is comprised of a ball and groove coupling comprised of:
an oval shaped open ring positioned in a recess on said nose portion of said base and;
one or more balls positioned in one or more tapered holes in said nose portion, wherein the one or more balls positioned in the one or more tapered holes do not protrude beyond an entrance of the one or more tapered holes; and
a sleeve that circumferentially and slidably covers the one or more balls positioned in the one or more tapered holes,
said sleeve having internal grooves shaped to interface with said oval shaped open ring and with said one or more balls;
wherein one of said internal grooves includes a recess shaped to contain and hold said oval shaped open ring in either one of two positions;
wherein one of said internal grooves includes a recess shaped to contain and hold said oval shaped open ring in one of two positions and wherein one of said internal grooves receives the one or more balls when said sleeve is in one of two positions.

6. The apparatus of claim 1, wherein said nose portion is configured with a collar, the collar permanently secured to a tool.

7. The apparatus of claim 1, wherein the sidewall portions of the base are adjustably mechanically connectable to said forearm cover.

8. An apparatus for wearing on a wrist and forearm of a person, the apparatus comprising:
a handle grip for gripping with a hand, said handle grip attached to a base extending from the handle grip along the forearm to a position near an elbow of the person, said handle grip incorporating an electrical switch,
said base including a platform for positioning and placing a forearm when the handle grip is gripped, said base having sidewall portions on each side that connect to a forearm cover, said forearm cover positioned around the forearm to substantially encase a circumference of the forearm,
said base having a nose portion extending distally in front of the handle grip;
said base having a connection means for electrically connecting a power source,
said nose comprising a lock and release mechanism incorporating an electrical connection means to electrically connect the various implements to said handle grip.

9. The apparatus of claim 8, wherein said lock and release mechanism is used for attachment and detachment of any one of various tools and implements.

10. The apparatus of claim 9, wherein said lock and release mechanism is comprised of a threaded coupling comprised of:
a thread made on said nose portion, said nose portion comprising a cylindrical nose portion; and
a mating thread made on tool attachments for threading onto the thread of said cylindrical nose portion.

11. The apparatus of claim 9, wherein said lock and release mechanism is comprised of a ball and groove coupling comprised of:
an oval shaped open ring positioned in a recess on said nose portion of said base and;
one or more balls positioned in one or more tapered holes in said nose portion, wherein the one or more balls positioned in the one or more tapered holes do not protrude beyond an entrance of the one or more tapered holes and;
a sleeve that circumferentially and slidably covers the one or more balls positioned in the one or more tapered holes,
said sleeve having internal grooves shaped to interface with said oval shaped open ring and with said one or more balls, wherein one of said internal grooves includes a recess shaped to contain and hold said oval shaped open ring in one of two positions and wherein one of said internal grooves receives the one or more balls when said sleeve is in one of two positions.

12. The apparatus of claim 8, wherein said lock and release mechanism comprises an electrical/mechanical connection means to electrically and mechanically connect any one of various tools and implements to the base.

13. The apparatus of claim 8, wherein said base comprises an electrical/mechanical connection means for mechanically and electrically connecting a power source.

14. The apparatus of claim 8, wherein said handle grip incorporates the electrical switch to initiate electrical current from the power source to any one of the various implements.

15. The apparatus of claim 8, wherein the sidewall portions of the base are adjustably mechanically connectable to said forearm cover.

16. The apparatus of claim 8, wherein said nose portion is cylindrical.

17. An apparatus for wearing on a wrist and forearm of a person, the apparatus comprising:
a handle grip for gripping with a hand, said handle grip attached to a base extending from the handle grip along the forearm to a position near an elbow of the person,
said base including a platform for positioning and placing a forearm when the handle grip is gripped, said base having sidewall portions on each side that connect to a forearm cover, said forearm cover positioned around the forearm to substantially encase a circumference of the forearm,
said base having a nose portion extending distally in front of the handle grip, said nose portion configured with a lock and release mechanism used for attachment and detachment of any one of various tools and/or implements,
said lock and release mechanism incorporating an electrical/mechanical connection means to electrically and mechanically connect the any one of various tools and/or implements to the base,
said lock and release mechanism incorporating an electrical connection means to electrically connect the various implements to the handle grip and to electrically connect the handle grip to a power source in the base;
said handle grip incorporating an electrical switch to initiate electrical current from the power source to the any one of the various tools and/or implements,
said base having a bottom portion configured to contain the power source.

18. An apparatus for wearing on a wrist and forearm of a person, the apparatus comprising:
a handle grip with a substantially flat mounting surface;
a base to which the handle grip is attached, the base extending rearward from the handle grip, wherein said base further includes:
a platform in contact with the mounting surface, the platform arranged to be coplanar with the mounting surface;
a forearm cover having at least in part a cylindrical shape and configured to at least partially enclose a forearm of the person;
sidewall portions on each side of the base that connect to the forearm cover; and
a nose portion extending distally in front of the handle grip, said nose portion configured with a lock and release mechanism configured to detachably couple to any one of a variety of tools and implements.

19. An apparatus for wearing on a wrist and forearm of a person, the apparatus comprising:
a handle grip for gripping with a hand, said handle grip attached to a base extending from the handle grip along the forearm to a position near an elbow of the person,
said base including a platform for positioning and placing a forearm when the handle grip is gripped, said base having sidewall portions on each side that connect to a forearm cover, said forearm cover positioned around the forearm to substantially encase a circumference of the forearm,
said base having a nose portion extending distally in front of the handle grip, said nose portion configured to permanently attach to any one of various tools or implements.
